(19) United States
(12) Patent Application Publication
(10) Pub. No.: US 2006/0214666 A1
(43) Pub. Date: Sep. 28, 2006

(54) Circuit board capable of indicating the temperature of hot elements thereon

(75) Inventors: Hung-Hsiang Chou, Peitou (TW); Chuan-Te Chang, Peitou (TW); Ching-Chung Chen, Peitou (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTeK Computer, Inc.

(21) Appl. No.: 11/364,216

(22) Filed: Feb. 28, 2006

(30) Foreign Application Priority Data
Mar. 25, 2005 (TW) 94109442

(51) Int. Cl. G01N 27/28

(52) U.S. Cl. 324/450

(57) ABSTRACT

A circuit board capable of indicating the temperature of hot elements thereon is disclosed. The circuit board includes a substrate, a hot element and a thermochromic material. The hot element may be a chip set or a CPU. The thermochromic material may be inorganic thermochromic materials, or organic thermochromic materials, such as polymers, liquid crystals, dyes, or combinations thereof.

### RELATED APPLICATIONS

The present application is based on, and claims priority from, Taiwan Application Serial Number 94109442, filed Mar. 25, 2005, the disclosure of which is hereby incorporated by reference herein in its entirety.

### BACKGROUND

1. Field of Invention

The present invention relates to circuit boards. More particularly, the present invention relates to circuit boards capable of indicating the temperature of hot elements thereon.

2. Description of Related Art

With the growth of processing speed and increase of functions, computers are now consuming more and more power, which makes the essential parts, i.e. the circuit boards, in the computers undertake more and more power conversion and generate more and more heat to be dissipated. If users want to examine the elements on the circuit board, they could likely get burned because they have no means for determining temperatures thereof. Consequently, in addition to the effort to further improve the efficiency for dissipating heat in order to avoid the hot elements such as CPU or chip sets on the circuit board being too hot, all manufactures are eventually required to face the problems that overheated elements frequently fail and make users get burned easily.

Reference is made to FIG. 1, illustrating a conventional circuit board where hot elements, for example, heat-generating elements such as CPU 111, voltage regulation module (VRM) 113, and IC 115, as well as heat-dissipating elements such as heat sink 121 and fan 131, are shown. To further improve the heat dissipation efficiency, some heat-generating elements are equipped with one or more heat-dissipating elements. VRM 113 is equipped with heat sink 121, IC 115 is equipped with fan 131 and CPU 111 is equipped with both heat sink 121 and fan 131, for example.

Most heat-dissipating elements are metal heat sinks made of aluminum or copper. If more are required, some active heat-dissipating elements such as fans can be introduced to enhance the dissipation of heat. This brings forth another problem, i.e. the surface temperature of a heat-dissipating element cannot be readily determined by naked eyes.

Presently, the way to determine the temperature of a heat-generating element is to equip the BIOS or DOS with a hardware monitor program in order to monitor the desired temperature profile. Even so, unless (1) the heat-generating elements on the circuit boards are equipped with hardware circuits, (2) BIOS or DOS functions normally, and (3) monitors are available for displaying the result, such a hardware monitor program is completely useless.

For the forgoing reasons, there is a need for circuit boards capable of indicating the temperature of the hot elements thereon, so that the idea “What you see is what you get” by naked eyes to help users know the rough temperature range of the hot elements on the circuit board in a computer can be realized.

### SUMMARY

One aspect of the present invention provides a circuit board capable of indicating the temperature of the hot elements thereon, so that the surface temperature of the hot elements can be identified in the absence of monitors.

Another aspect of the present invention provides a circuit board capable of indicating the temperature of the hot elements thereon, so that the failure of too-hot elements can be avoided as much as possible.

Still another aspect of the present invention provides a circuit board capable of indicating the temperature of the hot elements thereon, so that careless users are less likely to be burned by the hot elements.

In accordance with the foregoing and other aspects of the present invention, the present invention provides a circuit board. The circuit board includes a substrate, at least one hot element and a thermochromic material which changes its color according to a pre-determined temperature. The at least one hot element may be a heat-generating element such as a chip set or a CPU, or a heat-dissipating element such as a heat sink. The thermochromic material at least partially covers a surface of the hot element to indicate a temperature condition of the hot element.

According to one preferred embodiment of the present invention, the heat-generating element may be, but is not limited to, a CPU, a chip set such as north bridge/south bridge, VRM, RAM, a MOS chip, LDO, a power MOS chip, IC, or a BJT chip. The heat-dissipating element may be a heat sink made of heat-conducting materials or other heat-dissipating elements such as an air-cooling element.

The thermochromic material may be inorganic thermochromic material, including Co, Ag, Hg, V, Cr, Cu, Tl or a combination thereof. In addition, the thermochromic material may also be organic thermochromic material, such as polymers, liquid crystals, dyes, or combinations thereof.

In accordance with another aspect of the present invention, the present invention provides a circuit board. The circuit board includes a substrate, a heat-generating element assembled on the substrate, a heat-dissipating element assembled on the heat-generating element, and a thermochromic material that changes color according to at least a pre-determined temperature. The heat-generating element may be a chip set or a CPU, and the heat-dissipating element may be a heat sink. The thermochromic material at least partially covers the heating-dissipating element to indicate a temperature condition of the heating- dissipating element.

According to one preferred embodiment of the present invention, the heat-generating element may be, but is not limited to, a CPU, a chip set such as north bridge/south bridge, VRM, RAM, a MOS chip, LDO, a power MOS chip, IC, or a BJT chip. The heat-dissipating element may be a heat sink made of heat-conducting materials or other heat-dissipating elements, such as an air-cooling element.

The thermochromic material may be inorganic thermochromic material, including Co, Ag, Hg, V, Cr, Cu, Tl or the combination thereof. In addition, the thermochromic material may also be organic thermochromic material, such as polymers, liquid crystals, dyes, or combinations thereof.

In accordance with the circuit board of the present invention capable of indicating the temperature of the hot elements thereon, the surface temperature of the hot elements can be identified in the absence of monitors.

Besides, according to the circuit board of the present invention capable of indicating the temperature of the hot elements thereon, the possibility of failure caused by overheated elements can be lowered.

Additionally, with the help of the circuit board of the present invention capable of indicating the temperature of the hot elements thereon, careless users are less likely to be burned by the hot elements.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 is a perspective view of a conventional circuit board;

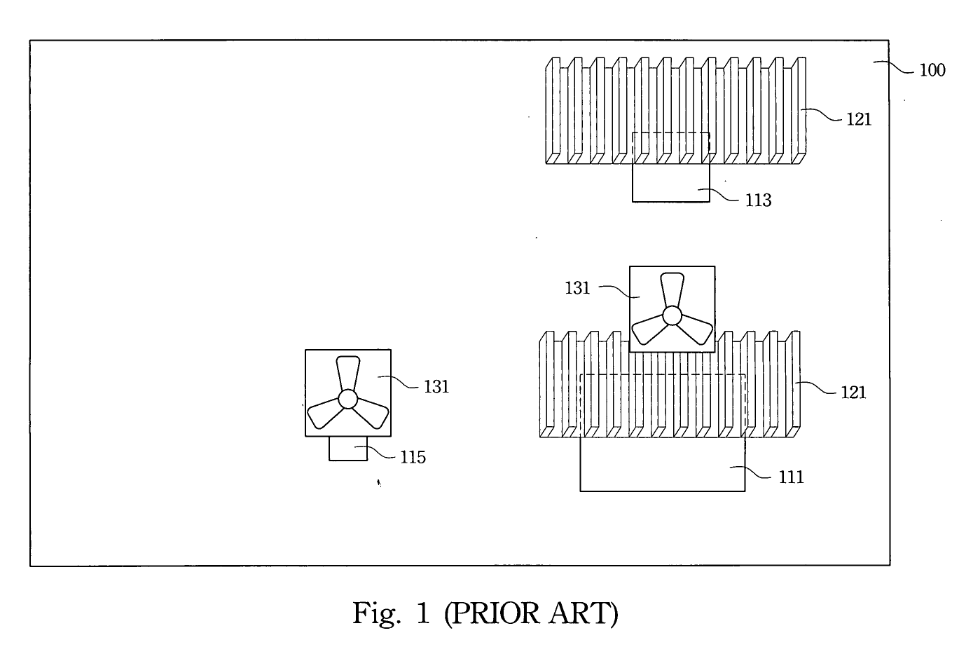

FIG. 2 is a perspective view according to one preferred embodiment of the present invention illustrating various hot elements and how thermochromic materials may go with the hot elements; and

FIG. 3 is a perspective view according to another preferred embodiment of this invention, illustrating the implementation of the thermochromic materials of the present invention.

### DESCRIPTION OF THE PREFERRED EMBODIMENTS

Reference will now be made in detail to the present preferred embodiments of the invention, examples of which are illustrated in the accompanying drawings. Wherever possible, similar reference numbers are used in the drawings and the description to refer to the same or like parts.

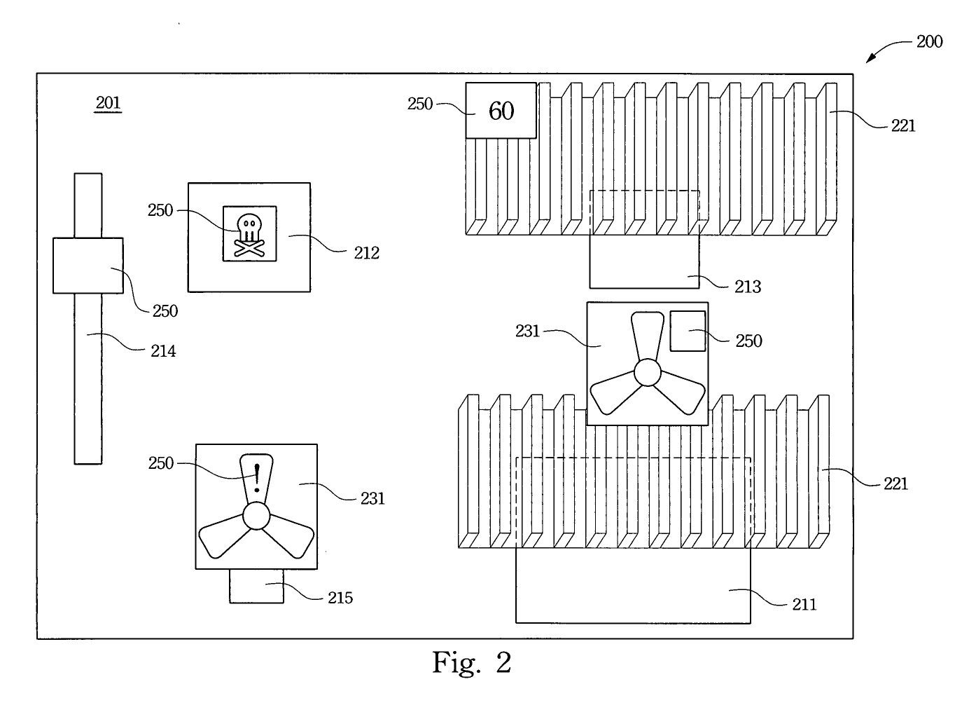

Reference is made to FIG. 2, illustrating a preferred embodiment of the circuit board of the present invention. The circuit board 200 for use in computers may include substrate 201, heat-generating elements 211, 212, 213, 214, and 215 assembled on substrate 201, and thermochromic material 250. The thermochromic material 250 at least partially covers the heat-generating elements, and changes color above a pre-determined temperature, instantly or gradually, to indicate a temperature condition of the heat-generating elements 211, 212, 213, 214 and 215.

The above-mentioned heat-generating elements are elements which can generate heat, such as, but not limited to, CPU 211, chip set 212 (south/north bridge), VRM 213, RAM 214, and IC 215, as well as a MOS chip, LDO, a power MOS chip, or a BJT chip.

For the improvement of dissipation of heat, shown in exemplary embodiment FIG. 2, substrate 201 may further include heat-dissipating elements 221 and 231. In an alternative embodiment, the heat-dissipating elements may be disposed on the heat-generating elements to enhance dissipation of heat.

The heat-dissipating elements are elements for dissipating excess heat. The heat-dissipating element 221 may be heat sink, preferably made of heat-conducting material such as Ag, Cu, Al, graphite, or the combination thereof. The heat-dissipating element may also be an air-cooling element, such as fan. Other suitable active heat-dissipating elements may include others known in the art, such as water-cooling elements, liquid-gas-cooling elements, or semiconductor-cooling elements.

Some heat-generating elements may be equipped with one or more heat-dissipating elements. For example, VRM 213 is equipped with heat sink 221, IC 215 is equipped with fan 231, and CPU 211 is equipped with both heat sink 221 and fan 231 at the same time.

In spite of this, provided that the heat-generating elements on the circuit board are not equipped with hardware circuits, or BIOS or DOS does not function normally, or monitors are not available for displaying the result, users are not able to readily identify the temperature of each element. Alternatively, when the housing of a computer is removed, users cannot easily tell by naked eyes if any element is overheated and may be burned due to neglect.

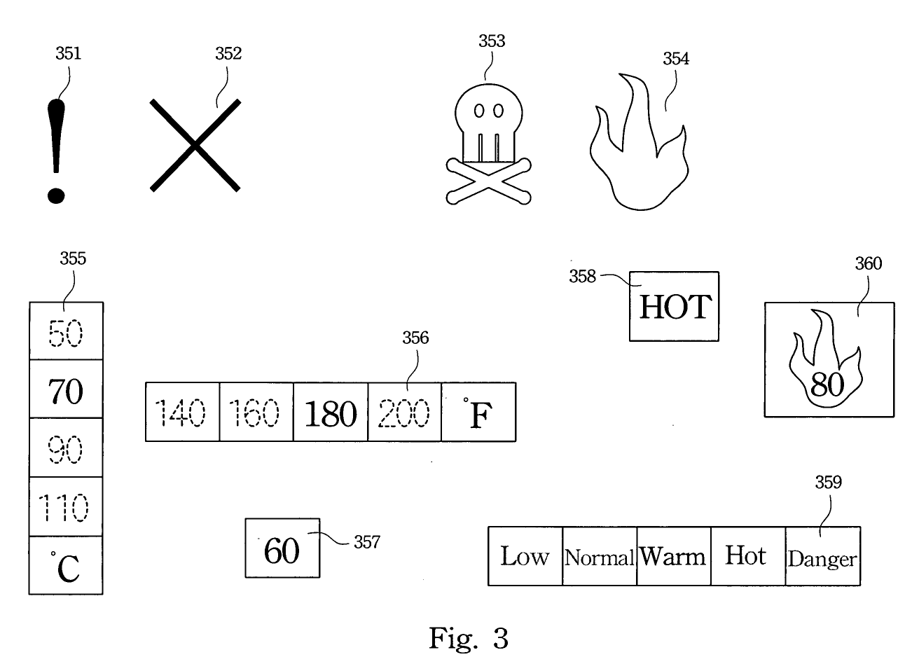

When thermochromic material 250 in the form of patterns or characters attached to the heat-generating elements, thermochromic material 250 is then able to indicate the temperature profile of the corresponding elements. The thermochromic material 250 preferably partially covers the heat-generating elements, such as, for example the thermochromic material 250 on heat sink 221, on chip set 212 and on fan 231. FIG. 3 illustrates various arrangements of thermochromic material 250 in the form of patterns or characters according to one preferred embodiment of the present invention, in which the temperature profile can be displayed by thermochromic material 250 in the form of illustrations 351/352, patterns 353/354, numerals 355/356/357, characters 358/359 or the combination thereof 360. Preferably, the color of thermochromic material 250 (illustrations 351/352, patterns 353/354, numerals 355/356/357, characters 358/359 or the combination thereof 360) changes to indicate the temperature profile when the temperature reaches a pre-determined value, “50° C.-70° C.-90° C.-110° C.”, for example.

Any material that changes color in accordance with change of temperature may be suitable thermochromic material 250. Thermochromic material 250 generally includes organic thermochromic materials and inorganic thermochromic materials.

Inorganic thermochromic materials are usually substances that include metal, such as Co, Ag, Hg, V, Cr, Cu, Tl, or combinations thereof. The inorganic thermochromic materials may be one single compound or compositions including various components, in the form of solid or microcapsules. A suitable ratio of components may modify the temperature range of color change. Compounds related to mercury may be a typical example, such as CuHgI₄ or Ag₂HgI₄. In addition, vanadates, chromates, or mixtures thereof are also possible, such as PbCrO₄, Pb₂₋ₜM_{y}Cr₁₋ₓQ_{X}O₅, Tl₂ₓM₂₍₁₋ₓ₎CrO₄ or MCrO₄, where M in Pb_{2-y}M_{y}Cr₁₋ₓQ_{X}O₅ may be Mo, W, S, Se, Te, Q may be Ti, Zr, Hf, Ta, Nb, Sn, 0≦x<1, 0<y<0.3, Pb₂CrO₅ for example. M in Tl₂ₓM₂₍₁₋ₓ₎CrO₄ may be Na, K, Rb, Cs, x is from 0-1, Tl₂CrO₄, for example. M in MCrO₄ may be Na₂, K₂, Rb₂, Cs₂, Sr₂, Tl₂, ⅓(Tl₂Mg₂), ½(Tl₂Sr), or ½(Tl₂Ba), Tl₂Ba(CrO₄)₂ for example.

Suitable inorganic thermochromic materials for use in a temperature range under 100° C. may be inorganic salts of nickel or cobalt with crystal water, or metal complex containing nitrogen ligand. For example, [(C₂H₅)₂NH₂]₂CuCl₄ changes color at about 43° C., and [(CH₃)₂CHNH₂]CuCl₃ changes color at about 52° C.

There are various known organic thermochromic materials. Suitable organic thermochromic materials may be, but are not limited to, polymer materials, liquid crystal materials such as cholesteric liquid crystals, dye materials such as leuco dyes, or combinations thereof. The organic thermochromic materials are advantageous because they are readily available and easily processed. Many of the above organic thermochromic materials and inorganic thermochromic materials are commercially available.

The combination of different thermochromic materials may produce indicators for different purposes. A range of 20-35° C. indicates room temperature; an indication range of 55-65° C. may prevent users from getting burned and an indication range around 90° C. may avoid an overheated element failing. Because the temperature range for color change is usually known, persons skilled in the art may practice the present invention at their own discretion.

There are many methods to incorporate the thermochromic materials in the hot elements, such as adherence, lamination, application, printing, or integral formation. The thermochromic material 250 may adhere to the surface of a hot element; for example, thermochromic material 250 adheres to heat sink 221 shown in FIG. 2. Thermochromic material 250 may be laminated in the hot elements during processing. Alternatively, thermochromic material 250 may be applied on part of or all of the surface of the hot elements, by using, for example, Temperature Indicating Crayous from Telatemp Corporation. Commercially available thermochromic printing inks may be directly printed on part of or all of the surface for convenience; for example, thermochromic material 250 is printed on chip set 212 shown in FIG. 2. Integral formation means blending thermochromic material 250 with the raw material of the hot element before the surface of the hot elements is formed. Different methods are used to meet different demands.

In the light of the preferred embodiments of the present invention, the present invention has several advantages:

1. The surface temperature is indicated in the absence of monitors.

2. Failure of overheated elements is avoided.

3. The possibility of getting burned is dramatically lowered.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A circuit board, comprising:
a substrate;
a heat-generating element, assembled on the substrate; and
a thermochromic material, which changes color according to a pre-determined temperature and at least partially covers a surface of the heat-generating element to indicate a temperature condition of the heat-generating element.

2. The circuit board of claim 1, wherein the heating-generating element is a chip-set.

3. The circuit board of claim 1, wherein the heat-generating element is a CPU.

4. The circuit board of claim 1, wherein the substrate further comprises a heat-dissipating element, which is a heat sink formed with a heat-conducting material comprising Ag, Cu, Al, graphite, or a combination thereof.

5. The circuit board of claim 4, wherein the heat-dissipating element is an air-cooling heat-dissipating element.

6. The circuit board of claim 1, wherein the thermochromic material is an organic thermochromic material or an inorganic thermochromic material.

7. The circuit board of claim 6, wherein the inorganic thermochromic material comprises Co, Ag, Hg, V, Cr, Cu, Tl, or a combination thereof.

8. The circuit board of claim 6, wherein the organic thermochromic material comprises a polymer material, a liquid crystal material, a dye material, or a combination thereof.

9. A circuit board, comprising:
a substrate;
a heat-generating element, assembled on the substrate;
a heat-dissipating element, assembled on the heat-generating element; and
a thermochromic material, which changes color according to at least a pre-determined temperature and at least partially covers the heating-dissipating element to indicate a temperature condition of the heating-dissipating element.

10. The circuit board of claim 9, wherein the heat-generating element is a CPU.

11. The circuit board of claim 9, wherein the heat-dissipating element is a heat sink formed with a heat-conducting material comprising Ag, Cu, Al, graphite, or a combination thereof.

12. The circuit board of claim 9, wherein the heat-dissipating element is an air-cooling heat-dissipating element.

13. The circuit board of claim 9, wherein the thermochromic material is an organic thermochromic material or an inorganic thermochromic material.

14. The circuit board of claim 13, wherein the inorganic thermochromic material comprises Co, Ag, Hg, V, Cr, Cu, Tl, or a combination thereof.

15. The circuit board of claim 13, wherein the organic thermochromic material comprises a polymer material, a liquid crystal material, a dye material, or a combination thereof.
